(19) United States
(12) Patent Application Publication
(10) Pub. No.: US 2008/0013113 A1
(43) Pub. Date: Jan. 17, 2008

(54) Printers and printing

(75) Inventors: Manuel Gonzalez, Malaga (ES); Daniel Tshisuaka, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/485,442

(22) Filed: Jul. 13, 2006

(51) Int. Cl. G06K 15/00

(52) U.S. Cl. 358/1.5

(57) ABSTRACT

A method of producing a printed digital document 200, the document 200 being provided with a pattern 12 of printed features 14 which provides positional information for a reader 20, the method comprising incorporating printing information which relates to at least one characteristic of the printing of the document with at least one of: the positional information; and an information entity in addition to the pattern of printed features.

This application claims priority from Great Britain patent application 0518855.2 filed on Sep. 16, 2005. The entire content of the aforementioned application is incorporated herein by reference.

### FIELD OF THE INVENTION

The present invention relates generally to printers and printing.

### BACKGROUND TO THE INVENTION

The invention arose out of a consideration of digital pen and paper systems, such as the Hewlett Packard® Forms Automation System (HP FAS). In such systems a user uses a digital pen (for example the Hewlett Packard® Digital Pen 250) in data entry areas of digital paper forms, and the pen forwards the data captured for further processing by an off-pen processor. It will be appreciated however that the invention has wider applicability. For example the data could be written with a conventional (ie non-digital) pen or other writing implement and then the completed form could be scanned into a computer for processing of the form.

FIG. 1 shows schematically a prior art A4 sheet 10 of Anoto® digital paper. This comprises a part of a very large non-repeating pattern 12 of dots or printed features 14. The overall pattern is large enough to cover 60,000,000 square kilometres. The pattern 12 is made from the dots which are printed using infra-red absorbing black ink. The dots 14 are spaced by a nominal spacing of 300 μm, but are offset from their nominal position a little way (about 50 μm), for example, north, south, east or west, from the nominal position.

The pattern may comprise a 4×4 array of dots or a 6×6 array of dots to define a cell. Each cell has its dots at a unique combination of positions in the pattern space so as to encode the location of the cell in the pattern space. Thus the pattern of dots/printed features provides a machine readable position-determining pattern adapted to enable a position in pattern space to be determined (by observing a local pattern).

The sheet 10 has a pale grey, or ‘off-white’, appearance due to the dots 14.

FIG. 2 schematically shows a known type of digital pen 20 adapted to write human readable ink in non-machine-readable IR transparent ink and to read a position provided by the dot pattern using infra-red wavelengths of light. The pen 20 has a housing 22, a processor 24 with access to a memory 26, a removable and replaceable ink nib and cartridge unit 28, a pressure sensor 29 adapted to be able to identify when the nib is pressed against a document, an infra-red LED emitter 30 adapted to emit infra-red light, an infra-red sensitive camera 32 (eg a CCD or CMOS sensor), a wireless telecommunications transceiver 34, and a removable and replaceable battery 36 and a clock 37 arranged to time stamp signals indicative of the position of the pen.

The digital pen 20, when in use writing on a page/marking a page of digital paper, recognises a cell (for example of dots 14) and the processor 24 establishes a position in the dot pattern from that image. In use the LED 30 emits infra-red light which is reflected by the page 10 and detected by the camera 32. The dots 14 absorb the infra-red and so are detectable against the generally reflective background. Of course, the ink of the dots might be especially reflective in order to distinguish them (and the paper less reflective), or they may fluoresce at a different wavelength from the radiation that excites them, the fluorescent wavelength being detected. The dots 14 are detectable against the background page.

The processor 24 processes position data acquired by the camera 32 from its reading of the dot pattern and the transceiver 34 communicates processed information from the processor 24 to a remote transceiver (eg a receiver linked to a PC). Typically that information will include information related to where in the dot pattern the pen is, or has been, and its pattern of movement, and the time, which is derived from the clock 37, at which the writing nib of the pen 20 was at any particular position.

One prior art system is shown in GB 2 361 211 in the name of Hewlett Packard Company which discloses a forensic marking system for identifying the printing device on which a medium was printed by superimposing markings on a printed image. It is also known, for example PC World, 26 Oct. 2004, that manufacturer of engines for colour laser printers cause the engines to print a code onto paper printed by that engine.

According to a first aspect of the invention there is provided a method of producing a printed digital document, the document being provided with a pattern of printed features which provides positional information for a reader, the method comprising incorporating printing information which relates to at least one characteristic of the printing of the document with at least one of:
i. the positional information; and
ii. an information entity in addition to the pattern of printed features.

If the printing information is machine-readable then it may nevertheless be discernible and comprehensible by a human. However it is preferred that the information is not readily, or generally, discernible by a human; the pattern of printed features may provide a generally grey tint to a document on which it is provided but may mean nothing to a human.

According to another aspect of the invention there is provided a printer control system adapted to control a printer comprising a data processor and a memory provided with control instructions, in which in use, the control instructions control the data processor to issue an output to cause machine-readable printing information to be incorporated into a printed digital document, the document being provided with a pattern of printed features, which provides positional information for a reader, the printing information providing at least one characteristic relating to the printing of the document, and the printing information being incorporated in at least one of:
i. the positional information; and
ii. an information entity in addition to the pattern of printed features.

According to a further aspect of the invention there is provided a printed digital document, the digital document comprising a pattern of printed features which provides positional information for a reader, and the document also being provided with printing information relating to at least one characteristic of the printing of the document, the printing information being incorporated as machine-readable information into at least one of the positional information and an information entity in addition to the pattern of printed features.

According to yet a further aspect of the invention there is provided printer control software which is configured, in use, to cause machine-readable printing information to be incorporated into a digital document to be printed, the digital document being provided with a pattern of printed features which provides positional information for a reader, and the machine-readable printing information relating to at least one characteristic of the printing of the document, the printing information being incorporated with the positional information.

According to another aspect of the invention there is provided a printer system comprising a printer and the printer control system.

According to another aspect of the invention there is provided a system for processing data captured by a reader which has read or is reading a printed digital document, the system comprising a data processor, a memory provided with control instructions and an input which is adapted to be connected to an output of the reader, the digital document being provided with a pattern of printed features which provides positional information to the reader, and the document further being provided with machine-readable printing information which relates to at least one characteristic of the printing of the document, the printing information being incorporated in at least one of the positional information and an information entity in addition to the pattern of printed features, and in use data captured by the reader is received through the input and the control instructions cause the processor to act on the captured data and thereby determine the printing information.

One aspect of the invention may be viewed as a method of controlling revenue in response to detected printing information.

According to another aspect of the invention there is provided a printer control system adapted to control a printer comprising a data processor and a memory provided with control instructions, in which in use, the memory controls the data processor to issue an output to cause machine-readable printing information, comprising information relating to at least one of an identifier, an identifier of an entity associated with the printer and at least one parameter of the printing conditions, to be incorporated into a printed digital document as the document is printed, the document being provided with a pattern of printed features which provides positional information for a reader, the printing information being incorporated into at least one of:
i. an information entity separate from the pattern of printed features; and
ii. the pattern of printed features.

Reference to machine readable data carrier herein may be taken to include any one or more of the following non-exhaustive list: a floppy disk, a hard drive, a CD-ROM, a DVD ROM or RAM (including -R/-RW and +R/+RW), a tape, any form of magneto optical drive, a transmitted signal (e.g. an Internet download or file transfer, or the like), a wire.

### BRIEF DESCRIPTION OF THE DRAWINGS

Various embodiments of the invention will now be described, by way of example only, in which:

FIG. 1 (prior art) shows schematically an A4 sheet 10 of Anoto® digital paper;

FIG. 2 (prior art) schematically shows a known type of digital pen 20 adapted to write human readable ink;

FIG. 3 is a schematic illustration of an embodiment of the invention comprising a printer system;

FIG. 4 is a schematic illustration of the printer system shown in FIG. 3;

FIG. 5 is a schematic illustration of a digital form in accordance with an embodiment of the invention;

FIGS. 6 and 7 show examples of how embodiments of the invention may embed printer related information into the dot pattern;

FIG. 8 is a flow diagram of a printing process in accordance with an embodiment of the invention performed by the printer system of FIG. 3 in printing a digital document,

FIG. 9 is a flow diagram of an embodiment of the invention comprising the various steps performed by the printer of the printer system of FIG. 3 on receiving instructions to print a digital document; and

FIG. 10 shows a modification to a dot pattern used by a further embodiment of the invention.

### DETAILED DESCRIPTION OF EMBODIMENTS OF THE INVENTION

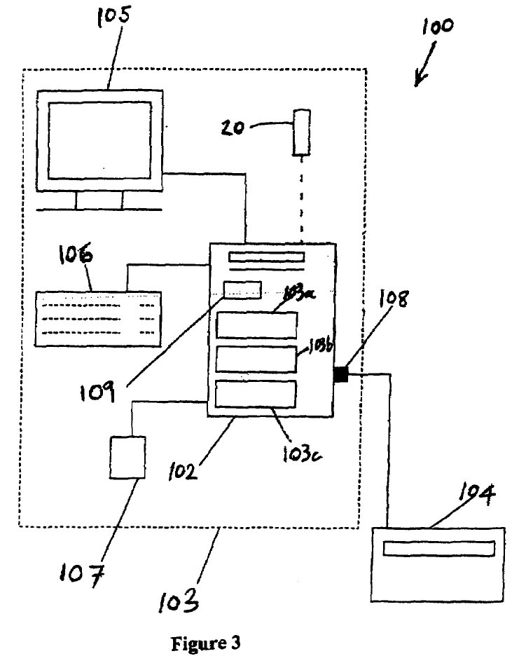

FIG. 3 is a schematic illustration of an embodiment of the invention comprising a system 100 for printing a digital document. The system 100 comprises a workstation 102 including a computing device, or processing device, such as a personal computer (PC) 103 which is connected to a hard copy producing device such as a printer 104. The workstation 102 includes a user interface which comprises a screen 105 and a user controlled input device such as a keyboard 106 and mouse 107 (and/or a voice controlled input means). The PC 103 has a processor 103a, a memory 103b and I/O devices 103c by means of which the processor 103a communicates with the screen 105, the keyboard 106 and the mouse 107, and a communications port 108 by means of which the processor 103a communicates with the printer 104.

The user controlled input device and/or the hard copy producing means are shown as being connected to the personal computer 103 via wired connections. It is possible that these devices could be connected to the PC 103 (or other computing device) via a wireless, or even a LAN or WAN connection.

The PC 103 comprises printer driver software 109 which allows the PC 103 to communicate with, and instruct, the printer 104. Position identification dot pattern data is stored in a repository associated with software which may conveniently be referred to as Service Controller which is stored in the memory 103b of the PC 103. More particularly, the Service Controller stores data relating to the generation of at least one pattern of dots which, when printed, will allow the position of the digital pen device (for example the pen 20) to be determined within a page printed with such a pattern. It may be the digital pen device that makes this determination or alternatively, or additionally, it may be an off-pen processing device such as the PC 103 (or other computing device) that makes this determination. The pen 20 may be thought of as a processing device in its own right.

It will be appreciated that the memory 103b need not be within the PC and could be connected to the PC 103 via a data connection thereto. The memory may be provided by any number of different storage technologies including volatile and non-volatile memories, hard disk drives, arrays of disk drives, tapes, etc. The term memory 103b is intended to cover each of these possibilities.

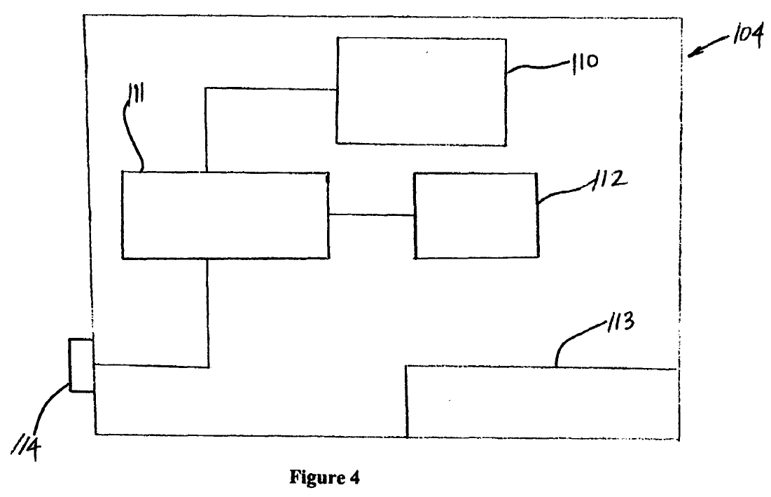

The printer 104, which as with the pen may be thought of as a processing device in its own right, is shown in more detail in FIG. 4 and comprises a printer head assembly shown generally at 110, a central processing unit 111, a memory 112 (which preferably comprises both re-writeable memory (eg RAM) and non re-writeable memory (eg ROM), a communications port 114, for enabling connection to the PC 103, (or a laptop or PDA, for example) and/or being adapted to receive a portable machine readable data carrier such as a memory card (eg Memory Stick™, Secure Digital (SD) card, USB storage devices, CDs, DVDs, flash memory cards). The printer 104 further comprises a paper tray 113 which stores a supply of paper to be printed on and a paper feed assembly (not illustrated) to convey the paper from the paper tray 113 to the printer head assembly 110.

The printer 104 may comprise any form of hard copy producing device including any of the non-exhaustive list: an inkjet printer or a laser printer (each of which may be colour or mono); a photo-copier; or the like.

The memory 112 of the printer 104 stores therein a program which may conveniently be referred to as ENCODE, which, when loaded onto the processor 111 is operative to embed machine-readable information into a positional dot pattern of a digital document to be printed. It will be appreciated that the functionality of ENCODE may be achieved by installing suitable plug-in software into the memory of the printer. Alternatively the functionality may be achieved by way of firmware which is installed at the time of manufacture of the printer 104, or for later flashing thereof in order to achieve a so-called upgrade of the firmware.

Although the expression ‘dot pattern’ is used herein and is intended to mean a pattern of round or roundish features, alternative realisations are equally possible in which a pattern of printed features of other outlines/shapes are used.

For the sake of simplicity the system 100 will be described with the example of the ENCODE program being adapted to incorporate into a positional dot pattern information indicative of the fact that the printer 104 is one which is manufactured by the Hewlett Packard company and hence free network Application Software may be used in conjunction with embodiments of the invention providing enhanced functionality to a user. The expression ‘printer-related information’ is intended to be understood generally so as to include information indicative of circumstances surrounding or associated with the printing of a digital document, and is not limited to characteristics of a particular printer. Different embodiments of the invention may provide different printer-related information but a non exhaustive list of such information includes: the time of printing, the date of printing, the identity of the printer, the identity of a computing device that caused the printing (which may be the IP, or other network, address); the level of toner within the printer.

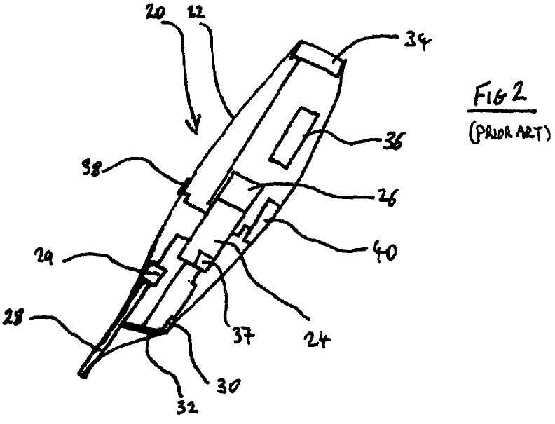

Looking at FIG. 2 (prior art) it will be seen that a 4×4 grid of dots is shown. Each dot can be displaced from an intersection of the grid by being moved upwards, downwards, left or right; ie there are four displacements of the dot from the grid intersection. It is possible to assign an arbitrary number to each of these displacements; eg 0=upwards; 1=left; 2=down; and 3=right. To encode this in binary will require 2 bits of information. Therefore, to encode the position of each of the dots within the 4×4 grid will require 32 bits (2 bits×4×4). If the grid is extended to a 6×6 grid this is increased to 72 bits (2 bits×6×6). Other sizes of grids are equally possible and would increase the number of bits available which could potentially be used to encode information.

In use, a user requires a document to be printed which is a digital form suitable for use with a digital pen (eg the digital pen 20). The user opens an application stored on the PC 103 (or within a memory accessible by the PC) and selects from a list of forms the required form. He then opens the file corresponding to the required form and displays the form on the screen 105 to ensure that that is indeed the required form. Using the keyboard 106 and/or the mouse 107, or any other input device to the PC 103, the user informs the PC 103 that he requires the form to be printed. In so doing the printer driver software 109 calls a suitable position identification dot pattern from the repository associated with the Service Controller. The Service Controller may be accessed via a network connection, which may be a Wide Area Connection, such as an Internet connection.

In other embodiments, the PC 103 may not be needed and another computing device (which may be the pen 20) may connect with the printer 104 to print the document.

In this embodiment the grid that is intended to be read by a digital pen (eg the digital pen 20) is 6×6 dots. However, as discussed above this could be any other number of dots. The dot pattern obtained from the Service Controller is limited to being 36 bits in length; ie half the number of bits required to fully specify the 6×6 grid. However, the Service Controller is arranged to ensure that the dot pattern issued to the printer driver software 109 is unique. It will be appreciated that the reduction of the number of bits allocated to dot pattern ie a reduction to 36 bits, will reduce the area of the pattern before it repeats.

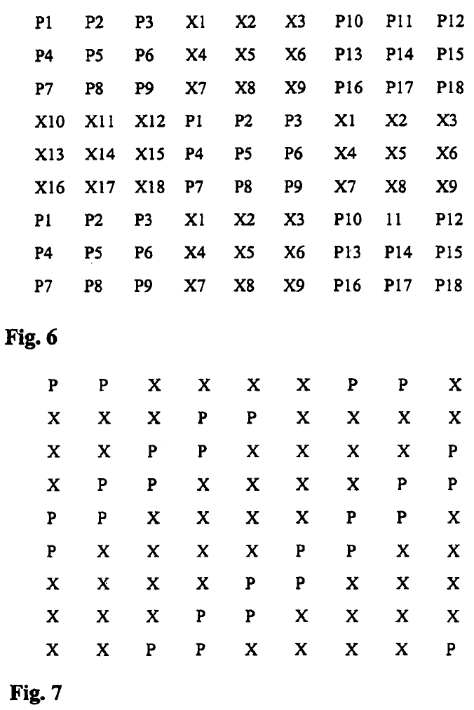

Embodiments of the invention may embed the printer related information in a different order and FIGS. 6 and 7 show examples of how this may be achieved. For instance, in one embodiment as exemplified by FIG. 6, bits of the printer related information as represented by a ‘P’ are arranged as 3×3 grids as are bits of the position information as represented by an ‘X’. Such an arrangement helps to ensure that in any 6×6 field of view the pen 20 can view 18 bits of printer information and 18 bits of position information. The number following both the ‘X’ and ‘P’ represents the bit number which in this embodiment is in the range 0 to 18.

As exemplified by the arrangement of FIG. 7 the bits need not be arranged in grids. Further, as will be seen from FIG. 7 there need not be the same number of bits of printer related information ‘P’ and position information ‘X’. Although FIG. 7 shows more position information than printer related information this may reversed such that there is more printer related information ‘P’ than position information ‘X’.

The printer driver 109 then combines the dot pattern with the data which is representative of the form to be printed. The printer driver software 109 then causes the form data (as combined with the dot pattern data) to be sent to the printer 104, together with data which informs the processor 111 of the printer 104 that the document to be printed will have a positional dot pattern.

On determining that a positional dot pattern is to be incorporated the processor 111 calls and loads the program ENCODE. ENCODE then causes the processor 111 to act on the positional dot pattern to incorporate therein information relating to the printing process. For example, the ENCODE program may incorporate any of the following pieces of information: how the document was printed, when the document was printed, where the document was printed, who caused the document to be printed, the temperature at which the document was printed, the amount of toner in the printer when the document was printed, the serial number of the printer, the manufacturer of the printer, or any other similar, or desired, information.

The inclusion of such information can be advantageous since it may allow the reading of the dot pattern by a digital pen 20 at a later time to be modified in order to take into account the printing conditions. For example, if the printer were running low on toner when the document was printed the dots may be fainter than usual which may be taken into account during reading of the dot pattern. Such an embodiment can be advantageous for a user of the pen 20 since it can help to reduce the errors that may occur during use of the pen; if the system cannot determine the position of the pen correctly because the pen cannot read the dot pattern then errors may occur. As a result the pen 20 may be caused to increase the power of IR output from the LED 30 although this may be considered disadvantageous due to increased power usage from the battery 36. Other embodiments may cause the system to perform more processing of the dot pattern in order to reduce errors. Yet a further embodiment may cause an output to a user asking him to move the pen more slowly due to the conditions.

It may be that the printer software 109 is configured to send instructions to the printer 104 as to what information is to be included as the printer-related information. Alternatively it may be that the PC 103 calls for the printer-related information from the printer, incorporates the printer-related information and then sends a request to the printer to print the document (with the printer-related information already incorporated).

It will be appreciated from the discussions above that in the current embodiment 36 bits are available in order to encode the printer related information. These 36 bits will correspond to the position of the last 18 dots in the grid and as such the information that is encoded in these bits will determine the position of the dots relative to the grid; the position of each dot will be determined by each two bit code according to the arbitrary coding (eg 0=upwards; 1=left; 2=down; and 3=right).

It will be appreciated that more bits would be available to encode printer related information if the fewer bits were used to encode dot pattern. However, as such the amount of available pattern would be reduced. Conversely, the amount of available pattern could be increased by reducing the number of bits used to encode printer related information.

The skilled person will appreciate that 36 bits of information does not provide much storage for information and as such the 36 bits may be used as an index in the same manner as indirect addressing is used. Thus, information, perhaps several kilobytes, megabytes or more, of information may be stored at an address referred to by the 36 bit address. It will be appreciated that a 36 bit address space provides of the order of 7×10¹⁰ addresses This address space size can be increased or reduced by using fewer or more bits respectively. The address referred to by the 36 bit address may be within any memory accessible by the pen 20 or PC 103.

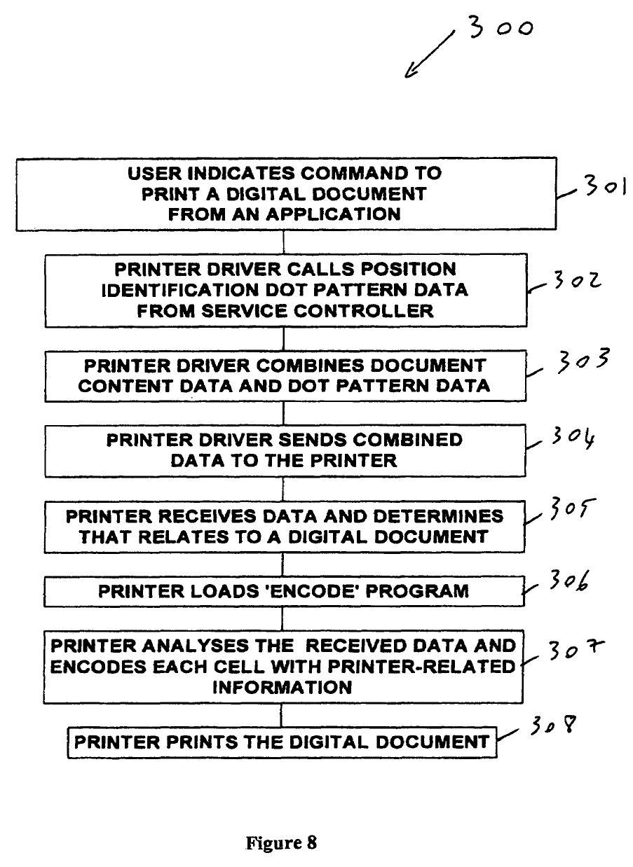

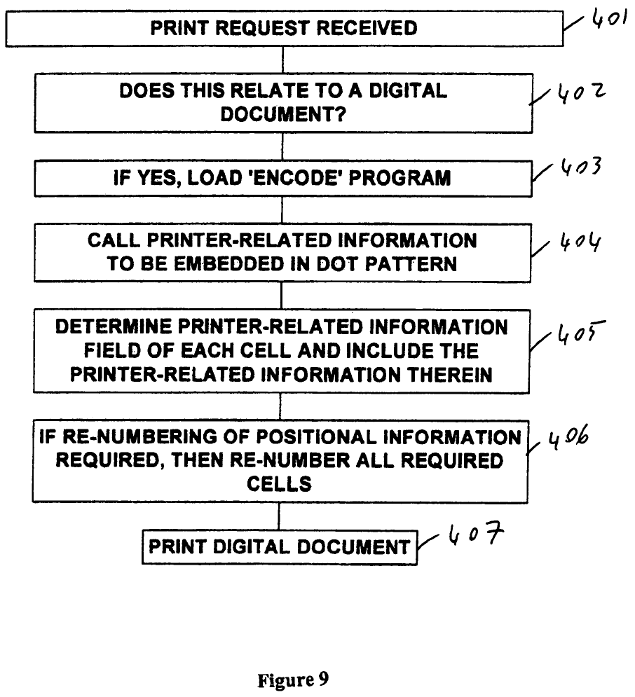

FIG. 8 shows a flow diagram 300 of one embodiment of the invention which summarises the various steps, 301 to 308, performed by the system 100 in printing a digital document. FIG. 9 shows a flow diagram of the process steps 401 to 407 implemented by the printer 104 in printing a digital document.

Once the positional information and the printer related information has been embedded, the document is then printed.

When the user completes any part of the printed form (where the dot pattern is present) the digital pen used will detect the printer-related information at each cell and store/forward this information as appropriate. In particular the pen will detect both those dots which represent positional information and those dots which represent the fact that the printer is a Hewlett Packard printer (or other printer related information). However, the first 36 bits of the data from the 6×6 grid are used to determine pattern information and as such identify the position of the pen 20 and the remaining 36 bits of information are used to obtain embedded information.

There are numerous ways in which the detected printer-related information can be used, for example by later uploading that information onto a PC. For example, it may be that if the printer-related information is indicative of the fact that the document was printed using a Hewlett Packard printer then this is communicated to the supplier and/or producer of the printer driver software 109 (and associated components such as the Service Controller and the ENCODE program). If a subscription is required for use of the software 109 then a discount to the next subscription can be applied. It may be that a predetermined number of documents printed having specific printer-related information needs to be detected before any discount is applied. If alternatively or additionally the printer-related information contained information indicative of the model of the printer used to print the document then discounts/special pricing rates could be applied on different scales, dependent on the model of printer used. Accordingly a method of controlling/policing revenue may be implemented thereby. In other embodiments discounts may be applied to the current or indeed, previous subscriptions.

If printer model or printer ID information were encoded then document production traceability could be improved since one could potentially trace a printer which produced a particular document. Thus one could have a plurality of printers each of which would be configured to embed with a positional dot pattern of a digital document an identity of a respective printer.

In an alternative embodiment in which the printer does not generate the last bits of a 6×6 grid each printer is configured to use one or more specific positional dot patterns, each of which has distinguishable characteristics, which is/are assigned to that printer. Each pattern, comprising a group of cells, is taken from the overall allowable pattern space. Thus the detected positional dot pattern could be used to indicate the printer used, and so printer-related information could be incorporated into a digital document in this manner. The Service Controller (or other means) is then arranged to record which pattern is assigned to which printer. In such embodiments the fact that the pen 20 is used on a pattern can be related back to the printer that printed that pattern through the record on the Service Controller. Thus, the pattern itself encodes the identity of the printer which printed the form, etc. which uses that pattern. In some embodiments the specific positional dot pattern may be embedded in the printer (or other hard copy producing device).

It may be that the digital pen 20 has stored therein one or more identities which relate to printers (each printer type, or specific printers of the same or different types) which produce documents, the dot patterns of which are supported by the pen 20. In this way one could avoid the risks to the end user of using a printer which is inappropriate, and also reduce the costs of providing technical support to customers. In such an arrangement the pen 20 could be configured to disable the strokes capture if it is detected that the dot pattern does not include one of the predetermined identifiers. An advantage of such embodiments may be that they can help to prevent theft of the pen 20. Such embodiments may be arranged to allow any one pen 20 to work with predetermined printers and vice versa.

More particularly when a user uses the digital pen 20 on a document printed with a dot pattern, information captured by the pen 20 from the dot pattern is (eventually) transmitted to the PC 103, and that information in then processed by the Service Controller. The Service Controller program is configured to determine the two fields of information and then to extract the data therefrom. In the case of the printer-related information the Service Controller may cause the PC 103 to communicate that information to a service provider so as to enable any discounts to be applied to as appropriate (as could be the case for the method of controlling revenue as mentioned above).

If the printer-related information was information as to one or more of the printing condition variables or the status of the printer used for printing a document, for example, toner levels used, temperature, print quality, then the algorithms of the pen's firmware could be optimised (for example the strokes' capture) in response to such information. In other words one or more printer variables could be used for the pen positioning decoding algorithms to optimise, or ‘fine tune’, the pattern recognition.

It may be that the printer-related information comprises the time and/or date of printing of the document, and so the encoded information could be viewed as a time/date stamp.

In one embodiment it may be that only every other cell contains printer-related information.

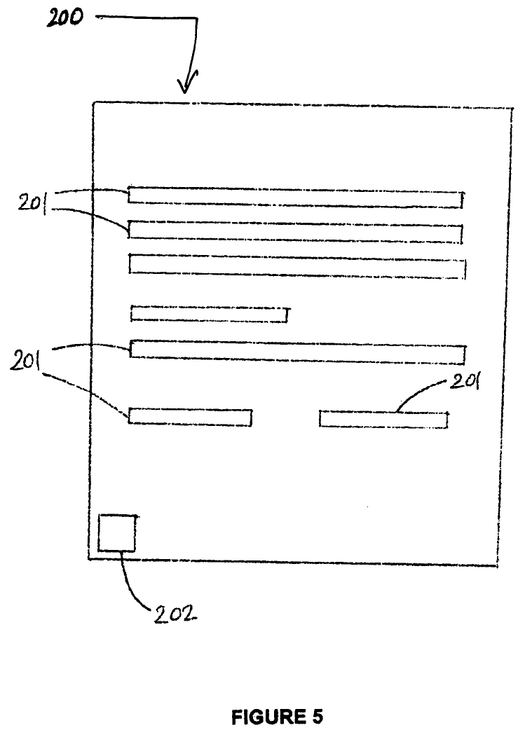

FIG. 5 shows an alternative embodiment of the invention in which printed digital form 200 comprises a plurality of data entry fields 201, each of which is provided which a positional dot pattern (which solely relates to positional information and not to any printer-related information). A region 202 is also printed on the document which region 202 contains a repeating dot pattern which encodes printer-related information. In use a user is required to strike through the region 202 with the digital pen 20 before attempting to complete the fields 201. The pen 20 is configured to enable the pattern recognition firmware if a required identifier is detected, the identifier being encoded by the dot patterns in the region 202. If such an identifier is successfully detected then when a user completes the form the pen's firmware will operate so as to capture the strokes made. Alternatively if no authorised identifier is detected or if the user commences to fill the fields 201 in without first striking through the region 202 then the pen's pattern recognition firmware will not be fully enabled. In such an embodiment the pen may be arranged to alert the user that it may not function correctly; for instance the pen may be arranged to vibrate; cause an LED, or other light output to be activated; sound a buzzer, or the like; or by any other suitable means.

In other words, it may be that a dot pattern encoding printer-related information is not embedded into the dot patterns for determining position, rather the two information types are printed as distinct and separate entities on a digital document.

In an alternative embodiment in the region 202 there is printed a bar code and/or 2D symbology which is indicative of printer-related information.

In yet a further embodiment it may be that the printer-related information is embedded with the positional information by dividing dot pattern cells into fields wherein the printer-related information is distributed over two or more cells. For example, a first cell may contain printer-related information comprising printer type or ID information, and a second cell (preferably an adjacent cell) may comprise a date and/or time stamp.

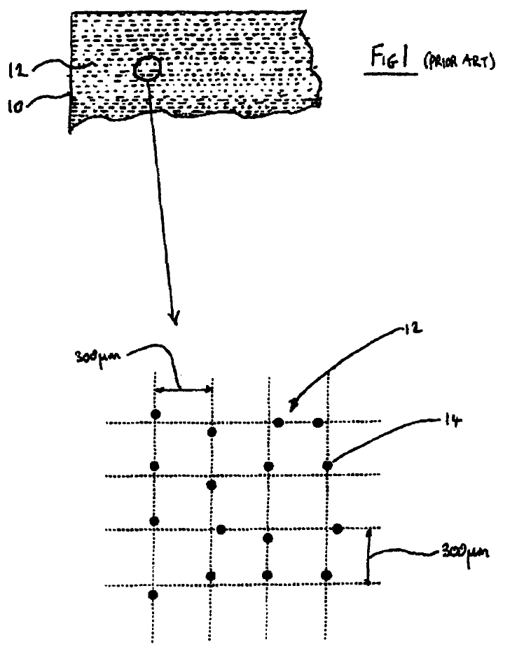

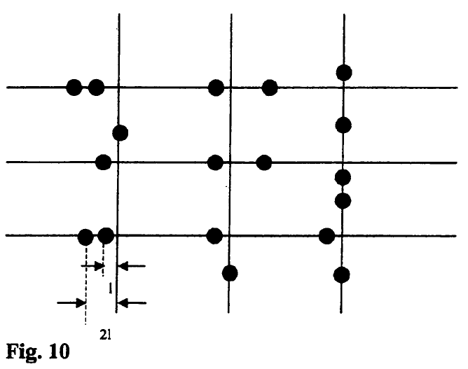

In another embodiment one or more additional dots may be incorporated into at least some of the cells of a dot pattern. Printer-related information may be indicated thereby by way of the position of one or more additional dots with respect to a cell and/or the number of dots in each cell and/or the pattern of such additional dots across multiple cells. An example of such an arrangement is shown in FIG. 10. FIG. 1 shows a prior art dot pattern in which a single dot is provided adjacent each intersection of a grid but displaced by a distance 1 therefrom. FIG. 10 shows an embodiment in which two dots are provided adjacent each intersection of the grid; one of the dots displaced by distance 1 and the other displaced by a distance 21. There may of course be many other arrangements.

In other embodiments a displacement of the dots relative to the grid may be changed. If the displacement were reduced when compared to FIG. 1 an increase in the density of dots would be provided.

Returning to FIG. 1, although the printer 104 is described as embedding the printer-related information into the dot pattern of a document to be printed, it may be that the PC 103 performs all the required processing so that a file of the document with the printer-related information already included therein is sent to the printer 104. In such an arrangement the Service Controller would have access to the required printer-related information, for example the make, type and ID of the connected printer.

In a further possible arrangement one of the printer 104 and the PC 103 has stored therein a number of ready-to-print documents, eg a form, which have already included therein printer-related information. Such an arrangement could be achieved after a form or other digital document has been created and printed, the form (with a dot pattern which includes printer-related information) is stored in a repository. It may be that the printer 104 comprises, or has associated therewith, a plurality of pre-prepared forms which a user can simply select and print. For example a printer may be provided with a user interface allowing a user to select the desired document. The user interface may comprise any one of a screen and an input means (which may be the screen).

It will be appreciated that when the printer-related information is encoded as a dot-pattern, or a part thereof, the information may merely be an index or precursor which has associated therewith, but stored elsewhere, a significant amount of information (which is retrieved subsequently, say by the PC 103, by use of a look-up table, database, or the like) that would otherwise be difficult to encode as a dot pattern.

Where, however, a significant amount of printer-related information is required to be incorporated with a document a further embodiment comprises a RFID chip which is attached to or embedded in the print medium. Such chips are known to have memories of 1 Mbit, dimensions of around 2 mm² and memory input and output is achieved by close range inductive coupling. A specially adapted printer (not illustrated) could hold a stock of sheets of paper which have embedded therein such a chip. On printing a digital document onto such paper the printer would write printer-related information onto the chip for subsequent retrieval by way of a suitable reader device.

As such embodiments of this invention allow a positional dot pattern of a digital document (eg a form) to incorporate information which relates to at least one characteristic of the printing of the document when the document is printed by the addition of the printer related information. For example information (printer related information) relating to the manufacturer ID of the printer which printed the document, the printer model, who printed the document, when the document was printed, how the document was printed (eg toner, temperature, ink type(s) and/or generally quality level) and/or when the document was printed.

1. A method of producing a printed digital document, the document being provided with a pattern of printed features which provides positional information for a reader, the method comprising incorporating printing information which relates to at least one characteristic of the printing of the document with at least one of:
i. the positional information; and
ii. an information entity in addition to the pattern of printed features.

2. A method as claimed in claim 1 in which the positional information and the printing information are each encoded by the position of dots within a dot pattern.

3. A method as claimed in claim 1 in which the printing information comprises information relating to one or more identifying characteristics of a printer and/or processing device which prints, or causes to be printed, the document.

4. A method as claimed in claim 3 in which the printing information comprises information relating to at least one of: the manufacturer of the printer, the model of the printer and the type of the printer.

5. A method as claimed in claim 1 in which the printing information comprises information which relates to one or more parameters of the printing conditions.

6. A method as claimed in claim 5 in which the printing information comprises information relating to at least one of toner level(s) used, print quality level, ink type(s) used and temperature.

7. A method as claimed in claim 1 in which the printing information comprises information relating to when the document is printed.

8. A method as claimed in claim 1 in which the printing information comprises information relating to an identity of an entity from which instructions are received to cause the document to be printed.

9. A method as claimed in claim 1 in which a printer which prints the document is configured to incorporate the printing information into data which that printer receives.

10. A method as claimed in claim 9 which comprises sending a print request to a printer, the print request comprising data representative of the document to be printed and the printer then incorporating into the document the printing information.

11. A printer control system adapted to control a printer comprising a data processor and a memory provided with control instructions in which, in use, the control instructions control the data processor to issue an output to cause machine-readable printing information to be incorporated into a printed digital document, the document being provided with a pattern of printed features, which pattern provides positional information for a reader, the printing information relating to at least one characteristic of the printing of the document, and the printing information being incorporated in at least one of:
i. the positional information; and
ii. an information entity in addition to the pattern of printed features.

12. A printer incorporating a printer control system according to claim 11.

13. System for processing data captured by a reader which has read or is reading a printed digital document, the system comprising a data processor, a memory provided with control instructions and an input which is adapted to be connected to an output of the reader, the digital document being provided with a pattern of printed features which provides positional information to the reader, and the document further being provided with machine-readable printing information which relates to at least one characteristic of the printing of the document, the printing information being incorporated in at least one of the positional information and an information entity in addition to the pattern of printed features, and in use data captured by the reader is received through the input and the control instructions cause the processor to act on the captured data and thereby determine the printing information.

14. System as claimed in claim 13 in which the processor uses the determined printing information to provide a control signal to the reader.

15. A printed digital document produced by the method of claim 1.
